(19) United States
(12) Patent Application Publication
(10) Pub. No.: US 2022/0107117 A1
(43) Pub. Date: Apr. 7, 2022

(54) D-SHAPED TORQUE TUBE AND BEARING ASSEMBLIES

(71) Applicant: NEXTracker Inc., Fremont, CA (US)

(72) Inventors: Ricardo Delgado-Nanez, San Jose, CA (US); Alexander W. AU, Oakland, CA (US)

(21) Appl. No.: 17/494,607

(22) Filed: Oct. 5, 2021

Related U.S. Application Data
(60) Provisional application No. 63/087,697, filed on Oct. 5, 2020.

(51) Int. Cl. F24S 30/425; H02S 20/32

(52) U.S. Cl. CPC F24S 30/425; H02S 20/10; H02S 20/32

(57) ABSTRACT

A solar tracker including a drive device, a D-shaped torque tube section configured to be rotated by the drive device, and at least one bearing configured to receive the D-shaped torque tube section, the D-shaped torque tube being suspended between the drive device and the bearing.

### BACKGROUND

### Technical Field

The present disclosure relates to solar power generation systems, and more particularly, to solar tracker actuating systems for adjusting the orientation of the solar power generation components to track the location of the sun.

### Background of Related Art

Solar cells and solar panels are most efficient in sunny conditions when oriented towards the sun at a certain angle. Many solar panel systems are designed in combination with solar trackers, which follow the sun's trajectory across the sky from east to west in order to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length.

Adjusting massive solar trackers requires power to drive the solar array as it follows the sun. As will be appreciated, the greater the load, the greater the amount of power necessary to drive the solar tracker. An additional design constraint of such systems is the rigidity required to accommodate the weight of the solar arrays and at times significant wind loading.

Further, the torsional excitation caused by wind loading exerts significant force upon the structure for supporting and the mechanisms for articulating the solar tracker. As such, increases in the size and number of components to reduce torsional excitation are required at varying locations along the length of the solar tracker. The present disclosure seeks to address the shortcomings of prior tracker systems.

### SUMMARY

One aspect of the disclosure is directed to a solar tracker including: a drive device, a d-shaped torque tube section configured to be rotated by the drive device. The solar tracker also includes at least one bearing configured to receive the d-shaped torque tube section, the d-shaped torque tube being suspended between the drive device and the bearing

Implementations of this aspect of the disclosure may include one or more of the following features. The solar tracker further including a plurality of d-shaped torque tube sections, each d-shaped torque tube section including a swaged portion on at least one end, the swaged portion having dimensions configured to be received in an un-swaged portion of a d-shaped torque tube section. The solar tracker where the bearing includes a rotatable portion configured to receive the d-shaped torque tube. The solar tracker where the bearing incudes a base and a top portion, the rotatable portion being secured between the base and top portions. The solar tracker where the rotatable portion includes a tab, the tab configured to impact end points in a slot formed in the top portion to limit the rotation of the rotatable portion and the d-shaped torque tube. The solar tracker where the drive device is a slew drive. The solar tracker further including an adapter configured to receive or be received in the d-shaped torque tube section. The solar tracker where the bearing includes a housing having an opening formed therein configured to receive the d-shaped torque tube. The solar tracker where the housing is flared in a longitudinal direction of the torque tube section. The solar tracker where the housing includes a semi-spherical slot formed therein. The solar tracker further including pins secured in a base and rollers supported by the pins, the rollers being received in the slot and enabling rotation of the housing relative to the base. The solar tracker where the base is received within a portion of the flared housing. The solar tracker where the housing is received in the base. The solar tracker where the semi-spherical slot is included of a plurality of sections, each section having a different radius. The solar tracker where the bearing includes an arm configured to connect to a screw drive actuator. The solar tracker where the screw drive actuator is driven via a gear box by a shaft that extends from the drive device along a length of the solar tracker to extend or retract the screw drive actuator and rotate the solar tracker. The solar tracker where the drive device is a slew drive. The solar tracker further including a crank, the crank mechanically joining the slew drive to the d-shaped torque tube. The solar tracker where the crank includes a flange for mating the crank to the slew drive. The solar tracker further including a d-shaped tube portion configured to receive or be received in the d-shaped torque tube section, the d-shaped tube portion having a central axis offset from a central axis of the flange.

### BRIEF DESCRIPTION OF THE DRAWINGS

Various aspects and features of the present disclosure are described hereinbelow with reference to the drawings, wherein:

FIG. 1 is a top perspective view of a solar tracker section in accordance with the disclosure;

FIG. 2 is a top perspective view of a solar tracker in accordance with the disclosure;

FIG. 3 is a bottom perspective view of a further solar tracker section in accordance with the disclosure;

FIG. 4 is a bottom perspective view of a further solar tracker section in accordance with the disclosure;

FIG. 5A is a cross-sectional view of a D-shaped torque tube in accordance with the disclosure;

FIG. 5B is a perspective view of a D-shaped torque tube section in accordance with the disclosure;

FIG. 5C is a side view of a swaged end portion of the D-shaped torque tube section of FIG. 5B in accordance with the disclosure;

FIG. 5D is a perspective view of a crank for connecting the torque tube section of FIG. 5B to a slew drive in accordance with the disclosure;

FIG. 6A is a front view of a bearing assembly in a 0-angle position in accordance with the disclosure;

FIG. 6B is a front view of a bearing assembly in accordance with the disclosure with the housing rotated relative to the base in accordance with the disclosure;

FIG. 6C is a perspective view of a bearing assembly with a portion of a torque tube section in the housing in accordance with the disclosure;

FIG. 6D is a side view of a bearing assembly with a portion of a torque tube section in the housing in accordance with the disclosure;

FIG. 7A is a side perspective view of a bearing assembly in accordance with the disclosure;

FIG. 7B is a front view of a bearing assembly in accordance with the disclosure;

FIG. 7C is a bottom perspective view of bearing assembly in accordance with the disclosure;

FIG. 7 D is a top view of a bearing assembly in accordance with the disclosure;

FIG. 8 is a perspective view of a bearing assembly in accordance with the disclosure; a b bearing rotated; perspective view of an actuation mechanism in accordance with the disclosure;

FIG. 9A is a perspective view of a bearing having a portion of a D-shaped torque tube in the housing in accordance with the disclosure;

FIG. 9B is a front view a housing of the bearing of FIG. 9A in accordance with the disclosure;

FIG. 9C is a perspective view a housing of the bearing of FIG. 9A in accordance with the disclosure;

FIG. 9D is a side view a housing of the bearing of FIG. 9A in accordance with the disclosure;

FIG. 10A is a top perspective view of a portion of a solar tracker in accordance with the disclosure;

FIG. 10B is an end view of a portion of a solar tracker in accordance with the disclosure;

FIG. 10C is a top perspective view of a portion of a solar tracker in accordance with the disclosure;

FIG. 10D is a top perspective view of a portion of a solar tracker in accordance with the disclosure;

FIG. 11A is a bottom perspective view of a portion of a solar tracker in accordance with the disclosure;

FIG. 11B is a top perspective view of a slew drive and D-shaped torque tube adapter in accordance with the disclosure;

FIG. 11C is a top perspective view of a slew drive with D-shaped torque tube sections fitted the adapter of FIG. 11 B in accordance with the disclosure;

FIG. 11D is a bottom perspective view of a portion of a solar tracker in accordance with the disclosure;

FIG. 11E is an end view of a portion of a solar tracker in accordance with the disclosure;

FIG. 12A is a right perspective view of a bearing in accordance with the disclosure;

FIG. 12B is a right perspective view of a bearing in accordance with the disclosure;

FIG. 12 C is a perspective view of a rotatable insert of the bearing in FIGS. 12 A and 12 B in accordance with the disclosure; and

FIG. 12 D is a front view of a bearing in accordance with the disclosure.

### DETAILED DESCRIPTION

The present disclosure is directed to solar tracking systems. More particularly, the disclosure is directed to a tracker support and bearing system for a single axis solar tracker employing a D-shaped torque tube and bearings designed to accommodate the D-shaped torque tube. variable radius bearing.

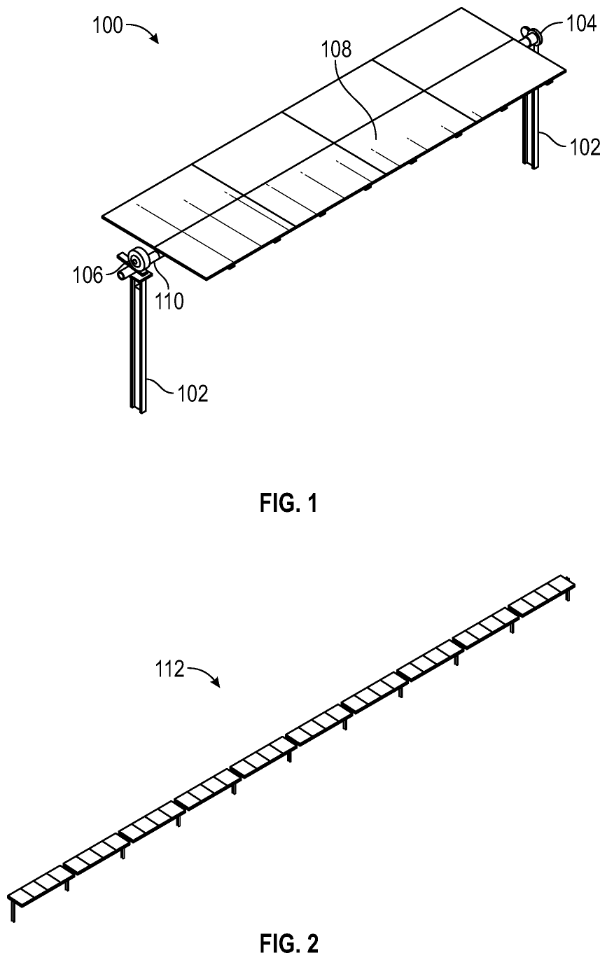

FIG. 1 depicts a known solar tracker section 100. The solar tracker section 100 includes two piers 102 a bearing 104 located on one of the piers 102 a slew drive 106 located on a second of the piers 102 and a plurality of solar panels 108. The solar panels 108 are supported by rails (not shown). And the rails are supported by a torque tube 110 suspended between the slew drive 106 and the bearing 104. In practice a number of these solar tracker sections 100 are connected together to form a single axis solar tracker 112 (FIG. 2), all being driven by the slew drive 106 to rotate the torque tube 110 and therewith the solar panels 108 such that they are oriented towards the sun, maximizing the energy production throughout the day. As depicted in FIG. 1, the torque tube 110 has a round construction. The bearing 104 is a pendulum type bearing, where the torque tube 110 is suspended from a pin, and the solar tracker section rotates about an axis defined by the axis of that pin.

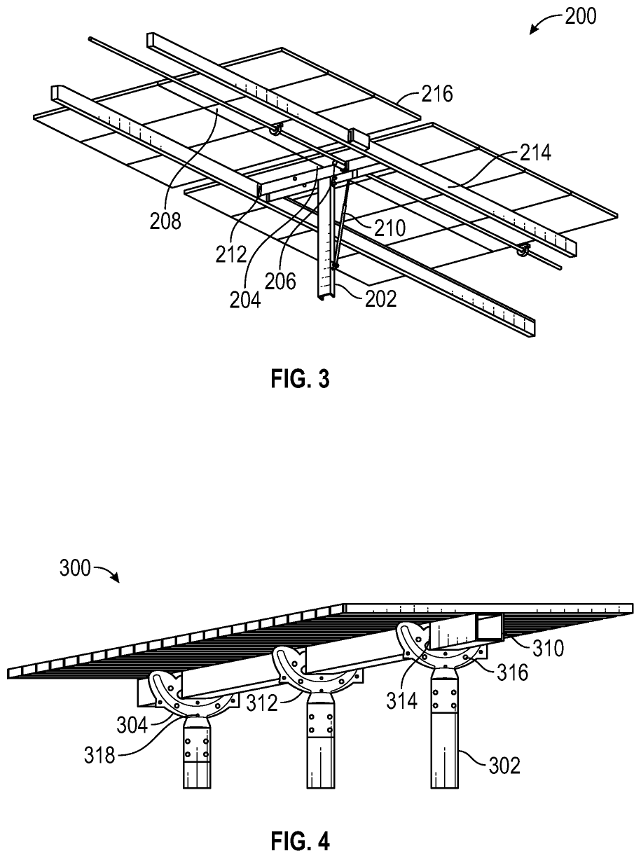

In FIG. 3 a second known solar tracker section 200 is depicted. Again, the solar tracker section 200 includes a number of piers 202. On each pier a bearing 204 is situated. A drive motor 206 is connected to a shaft 208 and geared via a gear box (not shown) to drive a screw actuator 210. One end of the screw actuator is rigidly connected to the pier 202, and an opposite end is connected to a pair of crossmembers 212, which connects to two longitudinal supports 214. The crossmembers 212 include the bearing 204 which connects the crossmembers 212 to the pier 202. Extension or retraction of the screw portion of the screw actuator 210 increases or shortens the length of the screw actuator 210 and forces the cross members 212, longitudinal supports 214 and solar panels 216 to rotate around the bearing 204. Though not a torque tube per se, the combination of the two crossmembers 212 and the two longitudinal supports 214 creates a frame on which the solar panels 216 rest and are moved to follow the position of the sun. The longitudinal supports 214 have a square cross section. Again, multiple of these solar tracker sections 200 can be combined to create a solar tracker 112 as generally depicted in FIG. 2. One distinction from FIG. 2, is that employing the drive motor 206 and shaft 208, allows for substantial elimination of any gaps between solar panels of adjacent solar tracker sections 200, and thus increases the potential energy yield for a given length of the solar tracker 112. The bearing 204, which may be a pin connected to both cross members, defines the axis of rotation for the solar tracker section 200.

FIG. 4 depicts yet another solar tracker section 300. The solar tracker section 300 includes piers 302 and bearings 304 located on each pier 302. Though not shown in FIG. 4, a drive motor, such as a slew drive 106 may be operatively connected to a torque tube 310 to move solar panels 308 secured to the torque tube 310 via rails (not shown) to orient the solar panels 308 towards the sun throughout the day. The bearing 304 includes a housing 312 that has a semi-circular shape and is configured to receive the square cross section torque tube 310. A semi-circular opening 314 machined into the support 312. Rollers 316 are received in the opening 314 and secured in place by partners 318 on each side of the support 312 that are connected together and to the pier 302. The bearing 304 allows torque tube 310, and the solar panels 308, to rotate about a point defined by the diameter of the semi-circular opening 314. That point which defines the axis of rotation is typically above the axis of the torque tube. Though described above in connection with a slew drive 106, the solar tracker section 300 may alternatively employ a drive motor 206 and shaft 208 along with screw actuators 210 located on certain of the piers 302 to achieve rotation of the torque tube 310 and the solar panels 308.

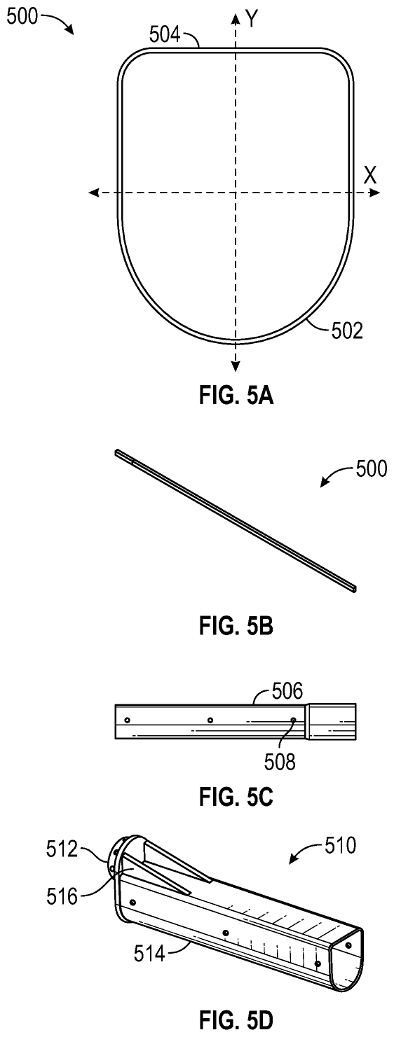

While the solar tracker sections 100, 200, and 300 are all quite effective and economical to manufacture, deploy, and maintain further improvements are desired to produce solar trackers at a lower cost, with greater structural stability, and improved performance. One aspect of the disclosure that seeks to achieve these advantages is the use of a new shape of torque tube. FIG. 5A depicts a cross-sectional view of a torque tube section 500 (FIG. 5B) having a D-shaped cross section. As will be described in greater detail below, the portion 502 of the torque tube section 500 having the arcuate shape will be oriented towards the ground when the solar tracker 112 is in a 0 angle position, as would be experienced when the sun is directly overhead. The D-shape maximizes the bending capacity of the torque tube section 500, particularly as compared to square or rectangular shaped torque tube 310, as depicted in FIG. 4 above. The D-shape also maintains a relatively large polar moment of inertia. The flat area 504 on the top side of the torque tube section 500 also allows for adjustability of rails to support solar panels 108, 216, 308 along the length of the torque tube 500 and solar tracker 112. Further, as will be disclosed in greater detail below, there are no restrictions on the placement of bearings, such as bearing 304 along the length of the torque tube section 500.

In accordance with one aspect of the disclosure, as shown in FIG. 5C, at least one end portion 506 of the torque tube section 500 is swaged to reduce the dimensions of the D-shape. These reduced dimensions are such that the end portion 506, can be inserted into an adjacent torque tube section 500. The combination of these two torque tube sections 500 will have a continuous outer dimension and appear substantially seamless at the joint. Holes 508 in the end portion 506 are placed to match with holes formed in the adjacent torque tube section 500, such that when the swaged end portion 506 is inserted therein, fasteners such as rivets, bolts, etc. can be inserted therein to secure the two adjacent torque tube sections 500 to each other. As will be appreciated, the interlocking D-shapes of the swaged end portion 506 and the adjacent torque tube section 500 provides a large surface area over which to transfer torque along the length of the solar tracker 112. Thus, the size of the fasteners inserted into the holes can be reduced in size since they are not required for the transfer of torque along the length of the solar tracker.

In addition, the overlapping of the swaged end portion 506 of the torque tube 500 which is inserted into the adjacent torque tube section 500 increases the stiffness in that portion of the torque tube 112. Where the solar tracker 112 is designed such that the overlapping of the swaged end portion 506 and the adjacent torque tube section is supported by a bearing (e.g., bearing 304) mounted on a pier (e.g., pier 204) the additional material in the area of the overlap provides for increased stiffness and resistance to bending at the locations along the solar tracker 112 which experience the greatest bending moment. This overlapped arrangement thus also allows for the reduction of the thickness and the overall dimensions of the torque tube section 500. All of which both reduce the costs of production and because the overall weight of the solar tracker 112 is reduced, reduces the energy required to move the solar tracker 112 through its progression from East to West as the sun moves through the sky.

FIG. 5D depicts a further aspect of the disclosure focused on a crank 510. The crank 510 has a flange 512 on one end. The flange 512 is configured to mate to a slew drive 106. The flange 512 is offset from a D-shaped tube portion 514. The tube portion 514 may be configured to receive a swaged end portion 506 of a torque tube section 500. Webs 516 help secure the flange 512 to the D-shaped tube portion 514 and provide resistance to bending moment on the connection of the flange 512 and the D-shaped tube portion 514. When attached to a slew drive 106, a central axis of the D-shaped tube portion 514 is offset from a central axis of the slew drive 106 (i.e., the central axis of the flange). The crank 510 allows for the incorporation of the D-shaped torque tube sections 500 in a solar tracker section 100 as seen in FIG. 1 incorporating the bearing 102 where the torque tube sections 500 are suspended from a pin which is aligned with the axis of rotation of the slew drive 106 to allow for rotation of the torque tube about that axis and not the axis of the torque tube.

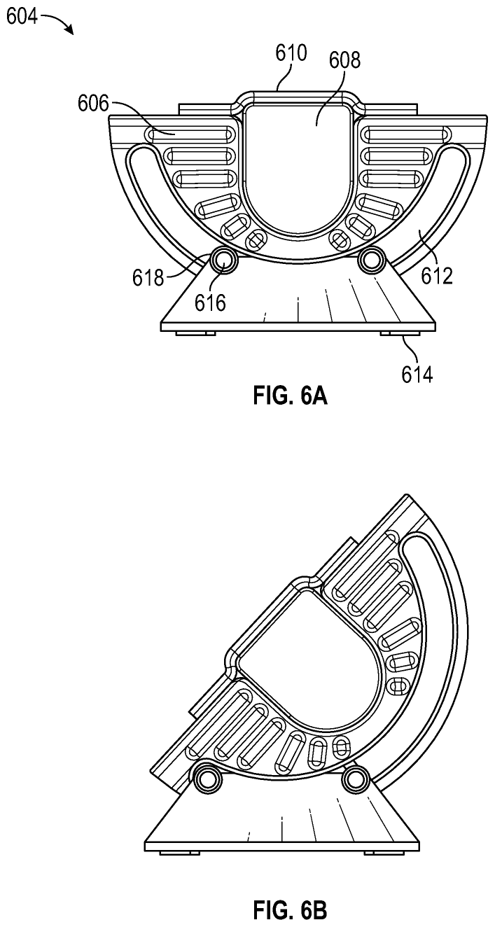

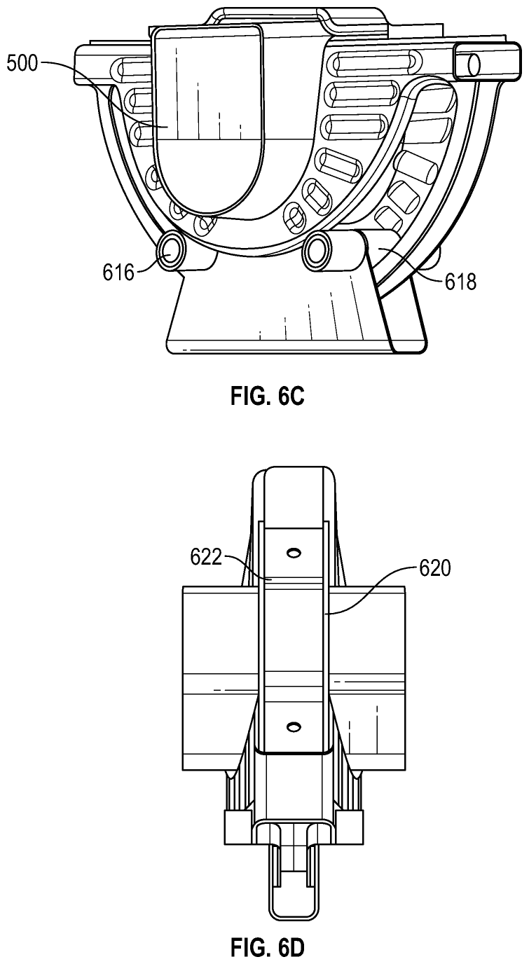

FIGS. 6A-6D depict a bearing 604, of similar construction to the bearing 304 of FIG. 4. Bearing 604 is optimized for the D-shaped torque tube section 500. Bearing 604, includes a housing 606. As shown in FIGS. 6A-6D the housing is substantially semi-circular, though other shapes are possible without departing from the scope of the disclosure. An opening 608 is formed in the housing 606 and configured to receive the torque tube section 500. A closure 610 retains the torque tube section 500 within the opening. This closure 610 may include one or more fasteners to secure the closure 610 to the housing 606. The housing 606 includes a semi-circular slot 612. The semi-circular slot 612 defines an arc about which the torque tube section 500 will be rotated when moved in one direction as depicted in FIG. 6B or in the opposite direction. A base 614 housings rollers 616 which are mounted on pins 618 to allow for rotation of the rollers relative to the base 614. The rollers 616 are configured to be received semi-circular slot 612 such that the portion of the housing 606 forming the smaller radius side of the semi-circular slot 612 rests on the rollers 616. The rollers 616 allow the housing 606 to rotate about an axis of rotation defined by the radius of the semi-circular slot 612. The portion of the housing 606 forming the larger radius portion of the semi-circular slot 612 rides under the rollers 616 and prevents any upward movement of the torque tube section 500, for example as might be experienced from wind loading of the solar panels, etc.

The housing 606 may be stamped or cast. Though appearing to be formed of a single flat piece of semi-circular material, the housing 606 is actually formed of a substantially circular material that is folded or bent along to edges 620 to form the semi-circular shape of the housing 606. The bending along edges 620 also forms flat 622 to which closure 612 can be secured and further provides for a substantially flat surface for receiving rails to which the solar panels may be mounted. This flat 622 helps reduce the overall height of the bearing 604 as no additional structure is necessary to achieve a substantially flat location for attachment of the rails. The bending along edges 620 to achieve the semi-circular shape of the housing 606, does not have to be to 90 degrees. Instead, by bending to less than 90 degrees, for example 75, 80, 85 degrees a slight flair is produced in the housing 606. This flair resists any axial loading that might be experienced by the solar tracker 112.

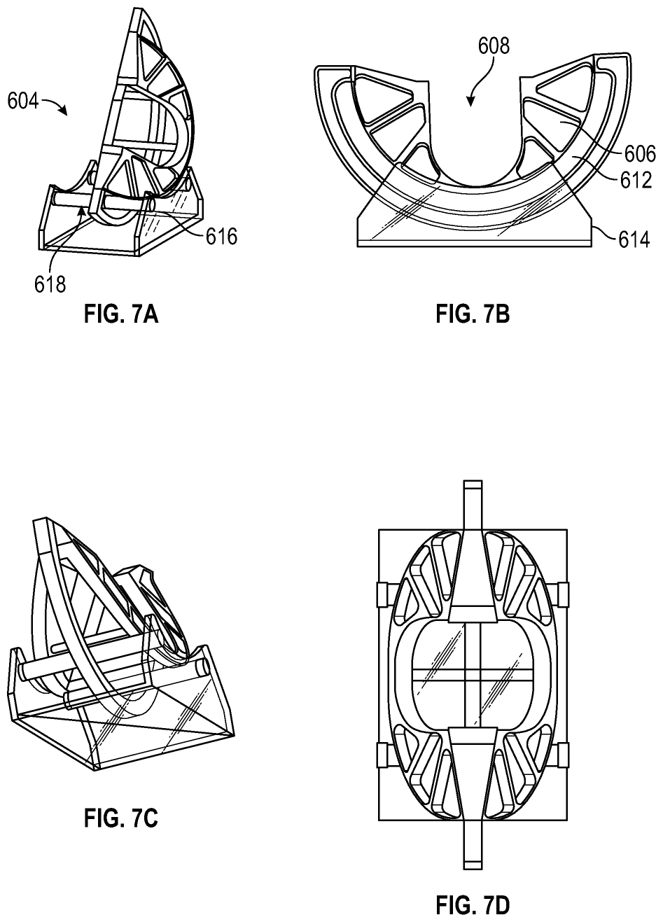

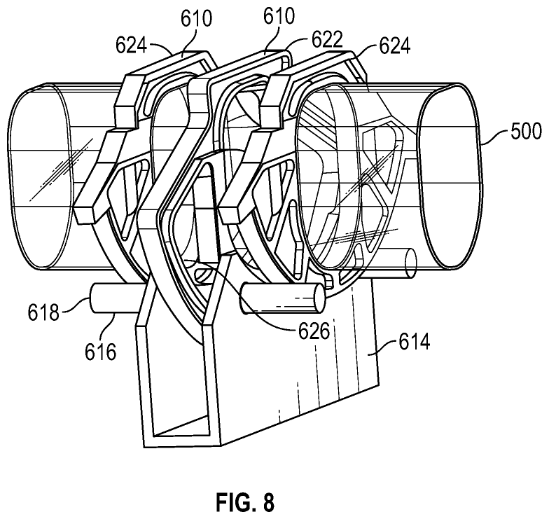

In a further aspect of the design the base 614 has a wider dimension than the partner 312 connecting the bearing 304 to pier 302 (FIG. 4). This wider base 614 provides greater resistance to twist along the axis of a pier as compared to the structure in FIG. 4. The portion of the housing 606 forming the larger radius portion of the semi-circular slot 612 may incorporate two further bends which reduce the axial width of the housing 606 in this area. As a result, the base 614 can as shown in FIGS. 6A-6D nests within the slot 612 with the pins 618 cantilevered on the sides by the flared sides of the housing 606. As an alternative, as shown in FIGS. 7A-7D the base 614 can also be wide and the pins 618 can reach from one side to the other with the entirety of the housing 606 within the base 614. FIG. 8 shows a further variation of the bearing 604 formed of three plates. A central plate 622 includes an opening 626 whose outer diameter defines a semicircular shape. Pins 618 pass through the base 614 and the opening to secure the central plate 622 and the torque tube section 500 to the base 614. The two outer plates 624 have a semicircular shape and an outer surface 626 rides on the rollers 616 supported by the pins 618. Both the D-shape of openings formed in the central plate 622 and the outer plates 624 secure the respective plates to the torque tube section 500. As with the embodiments of FIGS. 6A-6D, a closure 610 may be used to close the d-shaped opening in the central and outer plates 622, 624. Spacing between the central and outer plates 622, 624 enables the base 614 to be located between the central plate 622 and the two outer plates 624.

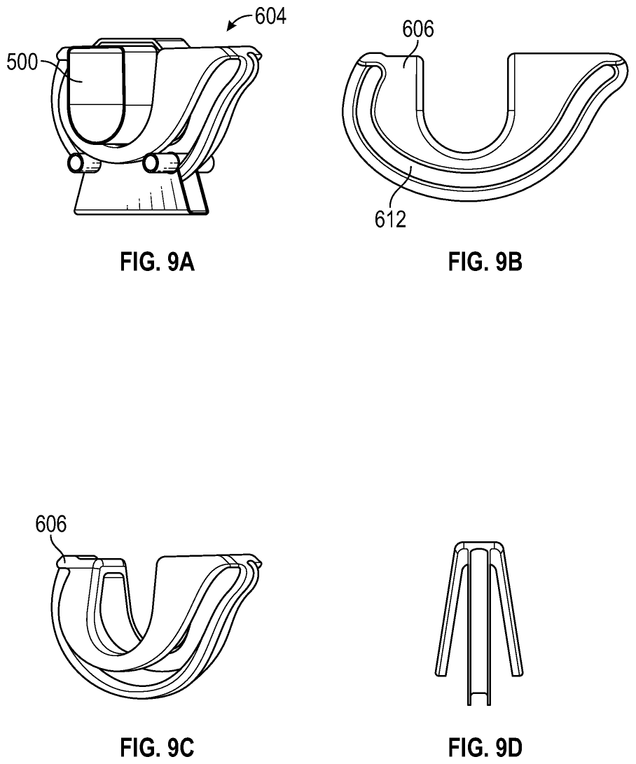

Though the slot 612 is generally described in herein as semi-circular it is not so limited and can take on other shapes formed of multiple different radii with different venters as shown in FIGS. 9A-9D. Still further, though the bearing 604 is

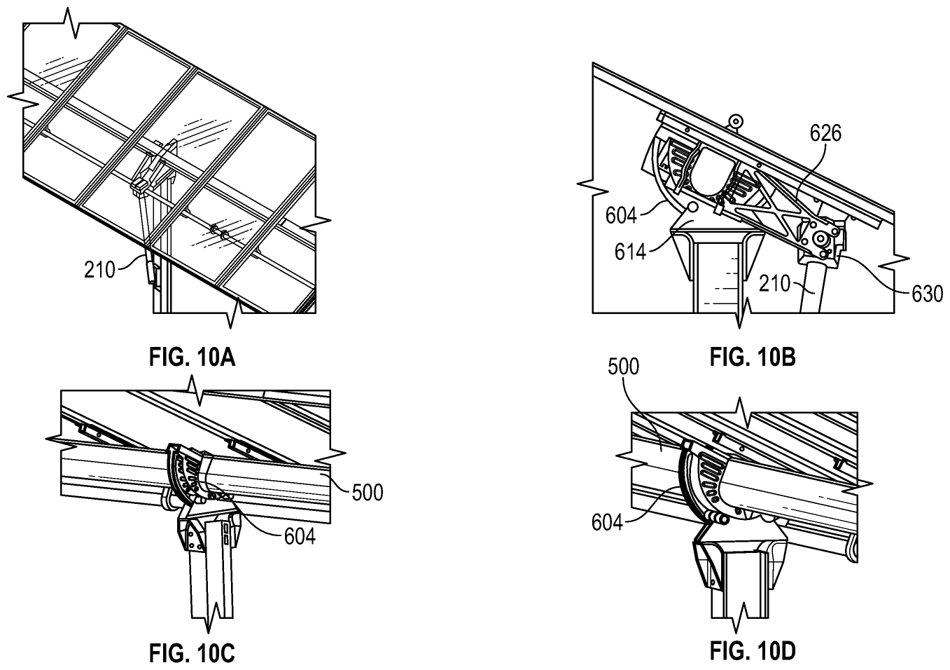

FIGS. 10A-10D depict the use of the bearing 604 in connection with a drive a screw actuator 210 for a solar tracker similar to what is shown in FIG. 3. As can be seen in FIGS. 10A and 10B, the bearing 604 is modified with an arm 628. The arm 626 connects the bearing to the screw actuator 210. The arm 628 is necessary to allow the torque tube 500 and the solar panels connected thereto to rotate through the entire range without interference. As can be seen in FIG. 10A shaft 208 intersects a gear box 630 at the top end of the screw actuator 610. As seen in FIGS. 10C and 10D, not every pier need have a screw actuator 210 to enable movement safe and effective movement of the torque tube 500 and the solar panels attached thereto. For the piers without the screw actuator 210, no arm 628 is necessary, and only the bearing 604 is needed.

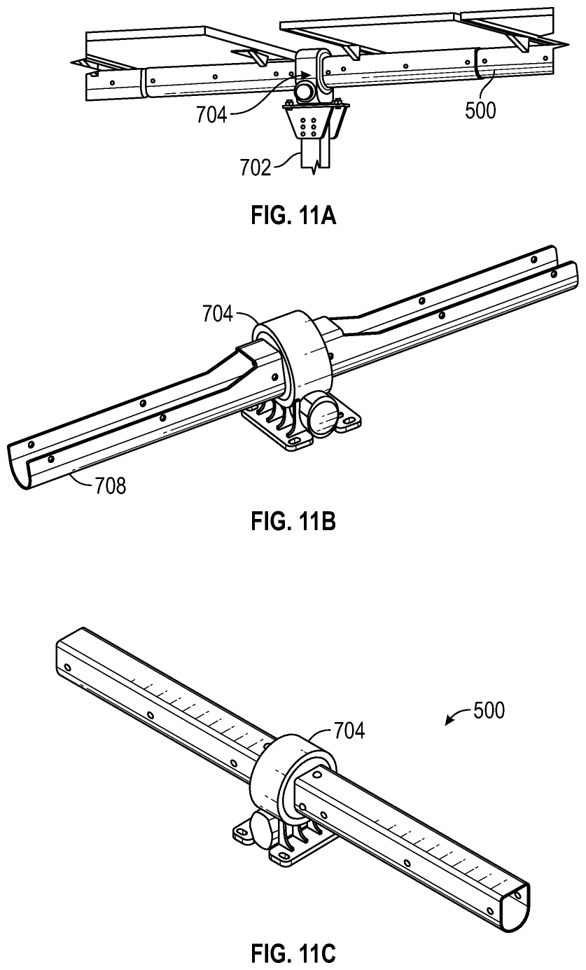

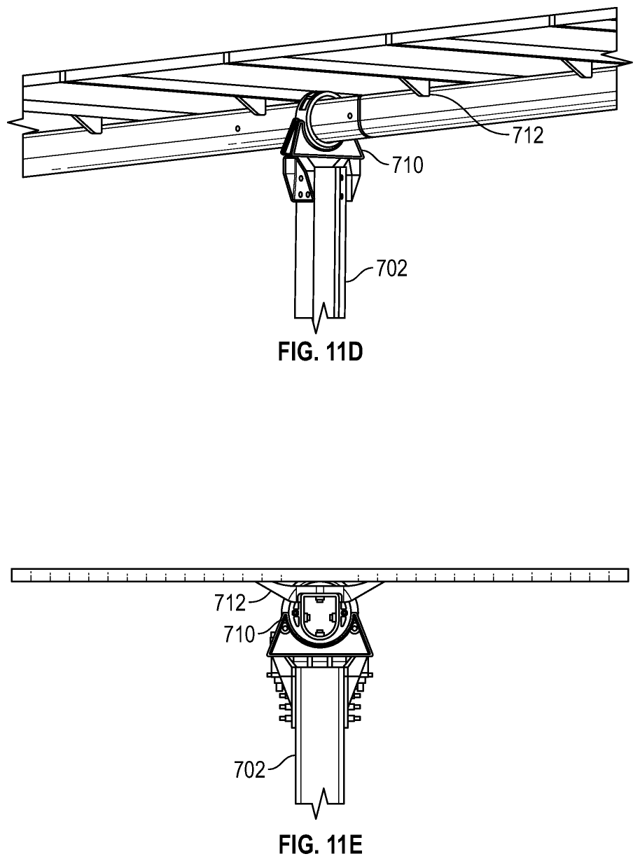

FIGS. 11A-11E depict a further embodiment of the disclosure employing a D-shaped torque tube section 500. As seen in FIG. 11A a pier 702 supports a slew drive 704. The slew drive 705 is configured to receive the D-shaped torque tube section 500, described herein above. Solar panels 706 are mounted on the flat top portion of the D-shaped torque tube section 500. In FIG. 11B, an adapter 708 is connected to the slew drive 704. The adapter 708 may be configured to be receive the swaged end of torque tube section 500. Additionally or alternatively, the adapter 708 can be configured to be received in the un-swaged end of the torque tube section 500. In either event, the torque tube section 500 is fastened via through bolts or rivets via holes in the adapter 708 and the torque tube section 500 that can be aligned. FIG. 11C shows the torque tube sections 500 connected to the adapter 708 and the slew drive 704. In FIGS. 11A and 11D it can be seen that the only portion along the length of the solar tracker 112 that requires a break in between solar panels is the area proximate the slew drive 704. FIGS. 11D and 11E depict a perspective and end view of the solar tracker 112 at areas with bearings 710. As with the other bearings disclosed herein, the bearings 710 are configured to receive the D-shaped torque tube sections 500. Also visible in FIGS. 11D and 11E are rails 712 which are connected to the torque tube section 500 and to which the solar panels 706 are also connected. In this embodiment, the axis of rotation of the solar tracker 112 is in fact the axis of rotation of the slew drive. That may or may not correspond to the central axis of torque tube section 500.

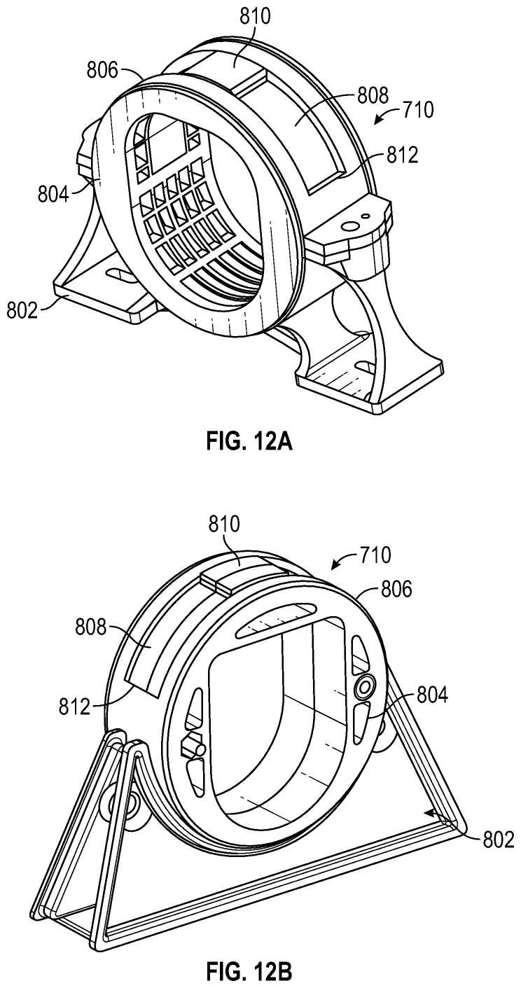

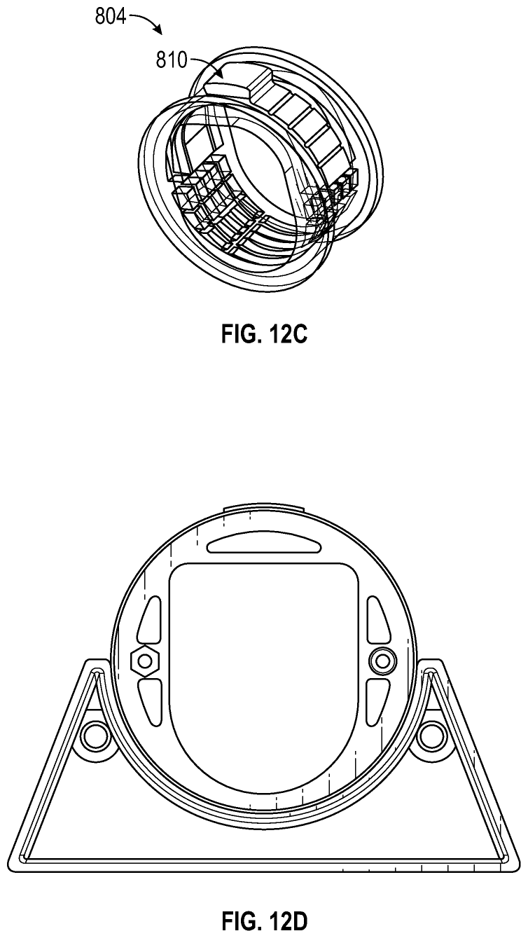

Further details regarding the bearings 710 are shown in FIGS. 12 A-12D. In FIG. 12A the bearing 710 has a three-part construction. A base 802 is configured for mounting on a pier as depicted in FIG. 11D. The base 802 has a generally circular interior shape and is also configured to receive a rotatable portion 804 (FIG. 11C). The rotatable portion includes flanges 806 to resist axial movement of rotatable portion 804 relative to the base 802. A top portion 806 secures to the base and encloses the rotatable portion between them. Bearing surfaces on the rotatable portion 804 allow for the rotatable portion 804 to rotate relative to the base 802 and top portion 806. A slot 808 formed in the top portion 806 is configured to receive a tab 810. The tab 810 moves in the slot 808 and prevents the torque tube section 500 from rotating beyond the end points 812. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

What is claimed is:

1. A solar tracker comprising:
a drive device;
a D-shaped torque tube section configured to be rotated by the drive device; and
at least one bearing configured to receive the D-shaped torque tube section, the D-shaped torque tube being suspended between the drive device and the bearing.

2. The solar tracker of claim 1, further comprising a plurality of D-shaped torque tube sections, each D-shaped torque tube section including a swaged portion on at least one end, the swaged portion having dimensions configured to be received in an un-swaged portion of a D-shaped torque tube section.

3. The solar tracker of claim 1, wherein the bearing includes a rotatable portion configured to receive the D-shaped torque tube.

4. The solar tracker of claim 3, wherein the bearing incudes a base and a top portion, the rotatable portion being secured between the base and top portions.

5. The solar tracker of claim 4, wherein the rotatable portion includes a tab, the tab configured to impact end points in a slot formed in the top portion to limit the rotation of the rotatable portion and the D-shaped torque tube.

6. The solar tracker of claim 5, wherein the drive device is a slew drive.

7. The solar tracker of claim 6, further comprising an adapter configured to receive or be received in the D-shaped torque tube section.

8. The solar tracker of claim 1, wherein the bearing includes a housing having an opening formed therein configured to receive the D-shaped torque tube.

9. The solar tracker of claim 8, wherein the housing is flared in a longitudinal direction of the torque tube section.

10. The solar tracker of claim 8, wherein the housing includes a semi-spherical slot formed therein.

11. The solar tracker of claim 10, further comprising pins secured in a base and rollers supported by the pins, the rollers being received in the slot and enabling rotation of the housing relative to the base.

12. The solar tracker of claim 10, wherein the base is received within a portion of the flared housing.

13. The solar tracker of claim 10, wherein the housing is received in the base.

14. The solar tracker of claim 10, wherein the semi-spherical slot is comprised of a plurality of sections, each section having a different radius.

15. The solar tracker of claim 10, wherein the bearing includes an arm configured to connect to a screw drive actuator.

16. The solar tracker of claim 15, wherein the screw drive actuator is driven via a gear box by a shaft that extends from the drive device along a length of the solar tracker to extend or retract the screw drive actuator and rotate the solar tracker.

17. The solar tracker of claim 10 wherein the drive device is a slew drive.

18. The solar tracker of claim 17, further comprising a crank, the crank mechanically joining the slew drive to the D-shaped torque tube.

19. The solar tracker of claim 18, wherein the crank includes a flange for mating the crank to the slew drive.

20. The solar tracker of claim 19, further comprising a D-shaped tube portion configured to receive or be received in the D-shaped torque tube section, the D-shaped tube portion having a central axis offset from a central axis of the flange.
